(19) United States
(12) Patent Application Publication
(10) Pub. No.: US 2007/0050281 A1
(43) Pub. Date: Mar. 1, 2007

(54) Committed bidder auction

(76) Inventor: Peter Holt Hoffman, Greenville, SC (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/216,737

(22) Filed: Aug. 31, 2005

(51) Int. Cl. G06Q 40/00

(52) U.S. Cl. 705/37

(57) ABSTRACT

A Committed Bidder Auction is a system and a process that is an alternative to an English Auction. In a Committed Bidder Auction, one or more of the unsuccessful bidders is obligated to pay some amount, a fraction of their final and largest bid. The “Dollar Auction” well known to game theorists and management students, is a special case, but it is extremely harsh to participants and so has little commercial applicability. The present invention both generalizes the prior art and provides gentler specific forms of the Committed Bidder Auction, which have potential for generating significant revenue.

### FIELD OF THE INVENTION

The present invention relates generally to conducting auctions. More particularly, it relates to auctions in which at least one unsuccessful bidder is committed to pay an amount to the House.

### BACKGROUND OF THE INVENTION

An auction is a process whereby property is sold. The auctioned property can be almost anything, including real estate, personal property, or services. An auction is managed by an “auction house,” or simply the “House.” A variety of auction formats are common (K. Reynolds, Auctions, 1996, http://www.agorics.com/Library/auctions.html), but most people are familiar with the “English Auction.” In the English Auction format, the auction is run by a person called an “auctioneer,” who orchestrates a bidding process on behalf of the House. The auctioneer signals the start of bidding on the auctioned property. Participants at their pleasure may place bids to buy it. Each bid must be higher than the previous one to be considered. When the auctioneer determines that no one else is inclined to bid, he closes the bidding. The winning bidder pays the final (and largest) amount he has bid and receives the auctioned property. The “unsuccessful bidders” receive nothing and pay nothing.

An auction (whether it has an English Auction or some other format) can be “with reserve,” meaning that if a “reserve criterion”—typically, requiring that the highest bid meet or exceed a predetermined minimum reserve amount—is not met, then the House can refuse to sell the property to the winning bidder. The fact that an auction is with reserve will be announced in advance, but ordinarily the exact reserve condition will not be announced. An auction can have a minimum starting bid, which might be the same as the reserve amount.

A “sealed bid auction” is a substantially different format from the “open bid” format of the English Auction. In the sealed bid format, bids are not made accessible to other bidders before the close of bidding. The auctioned property goes to the winner. Again, conventionally, the unsuccessful bidders receive nothing and pay nothing.

The conventional English Auction and sealed bid auction are “first-price” auctions, meaning that the winning bidder pays the highest amount bid (i.e., his own) for the auctioned property. A “second-price” auction is an alternative, applicable to either an English Auction or a sealed bid auction, in which the winning bidder pays the second highest bid that has been made (or some function of the amount of the second highest bid, such as that bid plus a constant amount).

Auctions are frequently conducted over electronic networks such as the Internet, with routine transactions, such as bidding and bookkeeping, managed on behalf of the House by computer software, possibly in lieu of a human auctioneer. Sellers advertise property for sale through the Web site hosting the auction. Potential buyers use browser software to access the Web site for placing bids. Bidding in such an auction usually closes at a certain time known in advance to the bidders.

In an “English Auction,” a bid is an offer to buy the auctioned property. When the bidding closes, assuming that any reserve criterion is met, the bidder receives the auctioned property. Assuming that the auction uses first-price bidding, the associated bidder is obliged to pay the bid's amount. (Henceforth, we will assume that the auction uses first-price bidding unless otherwise stated in a particular context.) The unsuccessful bidders have no obligation to pay, and receive nothing.

A “Dollar Auction” is a concept introduced by Martin Shubik in “The Dollar Auction Game: A Paradox in Noncooperative Behavior and Escalation” (J. Conflict Resol., 15, 1, 109-111, 1971). The Dollar Auction is an open bid format auction that takes its name from the property that was auctioned in Subik's original study, a U.S. one dollar bill. (In general, any property, not just a dollar bill, can be auctioned in a Dollar Auction format.) The only characteristic distinguishing the format of a Dollar Auction from an English Auction is that the persons making both the highest and the second highest bids are committed to pay the respective amounts of their bids. A Dollar Auction is always open bid format and closes at the discretion of an auctioneer. A Dollar Auction is never held with reserve. As in the English Auction, the highest bidder gets the auctioned property. The second highest bidder, however, receives nothing.

Research indicates that bidders often behave irrationally when they buy something in an auction, particularly an open bid format auction (G. Ku, “Auctions and Auction Fever: Explanations from Competitive Arousal and Framing,” Kellogg J. Organization Behavior, 2000 Issue, L. Thompson (ed.), 2001). This effect is greatly amplified in a Dollar Auction, in which the auctioned property will often sell for more than what it is actually worth, sometimes by orders of magnitude. According to J. Keith Murnighan (“Irrational Decisions and Getting Carried Away”, ch. 9 in Bargaining Games, William Murrow and Co. (1992)), bidders (and particularly bidders currently holding the second place bid) “face three issues: (1) How much can I afford to lose? (2) How can I look tough enough to scare the other bidder out of bidding more? And (3) how do I get out of this predicament without looking like a total fool?”

Despite the fact that the English Auction and the Dollar Auction are almost identical in format, the dynamics and the bidder psychology of the two auctions are dramatically different. This illustrates that even an apparently small change in the structure of bidder commitments to pay can have a major impact on the viability of an auction format.

Considerable progress has been made on Internet-based auctions. Of some relevance to the present invention is the work of Anderson et al. (U.S. Pat. No. 6,671,674B1), which provides a system where the bidders must each buy a nonrefundable share to participate in the auction. The share price can help the seller receive the desired amount for the item, or can reduce the amount that the winning bidder must pay for the item. The winning bidder can be the highest bidder or the person who was the k-th percentile bidder for some value of k less than 100% preselected by the House. Similarly, Feinberg (U.S. Pat. No. 6,366,891B1) requires that potential bidders pay a right to bid on an item. Only when the total of such payments exceeds a certain amount is an auction held. Megiddo (U.S. Pat. No. 6,665,649B1) teaches a randomized time for a close of bidding to provide a smooth ending system for an auction. The randomized time is chosen from an exponential probability distribution.

### SUMMARY OF THE INVENTION

To our knowledge, the Dollar Auction format has been primarily, if not exclusively, of pedantic interest, limited to research in game theory and classroom exercises in business management. Why would anyone choose to accede to the inherent financial and emotional traps of a commercial Dollar Auction when there are plenty of opportunities to shop through formats less adverse to buyers, whether by a more conventional auction format or a simple sale transaction?

Needless to say, however, the prospect of tapping a bit of the exuberance of a Dollar Auction would be very appealing to sellers. The present invention is a generalization of concepts underlying the Dollar Auction. The harshness of the Dollar Auction will be sufficiently moderated in some embodiments to attract prospective buyers.

To proceed further in describing the present invention, we need to coin some terminology. We call a bidder that has to pay some amount to the House a “committed bidder.” Any auction, such as an English Auction, in which the only committed bidder is the winner, will be referred to as a “Committed Winner Auction.” In contrast, if any unsuccessful bidders must pay the House, as in the Dollar Auction where the runner-up bidder is committed for the amount of his bid and receives nothing in return, then the auction will be referred to as a “Committed Bidder Auction.” A generalized Committed Bidder Auction, encompassing all those Committed Bidder Auctions other than the Dollar Auction (which is a very special case) is the subject of the present invention.

Every embodiment of the claimed invention is materially distinct from the prior art Dollar Auction format in one or more of the following respects: (1) two or more unsuccessful bidders are committed to pay something to the House; (2) the amount of the commitment of some or all of the unsuccessful bidders is greater than zero but less than 100% of the amount they have bid; (3) the amount of the commitment of the winner is less than 100% of the amount the winner has bid; (4) a sealed bid format is used; (5) the bidding closes at a time randomly selected by the House prior to the start of the bidding, and kept secret while bidding is in progress; and (6) the bidding closes at an announced fixed time.

The invention is distinct from the inventions of Anderson (U.S. Pat. No. 6,671,674B1) and Feinberg (U.S. Pat. No. 6,366,891B1), in which a potential bidder pays a uniform amount to participate. In the approach of the present invention, the amount that must be paid by an unsuccessful committed bidder is related to the bidding, and in many embodiments, including the preferred embodiment, is proportionate to their own bid. Lacking any relationship to the amount a participant has bid, the Anderson and Feinberg approaches do not tap the heightened auction fever associated with Committed Bidder Auctions such as the Dollar Auction.

While all embodiments of the Committed Bidder Auction are generalizations of the Dollar Auction, some of them are generalizations of the second-price format as well. We have created the term “transferred commitment format” for an auction in which the commitment by a bidder is based, in whole or in part, on a bid made by another bidder. The conventional second-price auction is a Committed Winner Auction that is also a transferred commitment format auction because the winner pays the “second-price”, the amount bid by the runner-up.

The present invention encompasses, in addition to most embodiments of Committed Bidder Auctions in which a bidder's commitment is based entirely on her own bid, every Committed Bidder Auction utilizing transferred commitments, One example auction that has committed unsuccessful bidders and transferred commitment is one conducted essentially under an English Auction format in which the highest bidder is committed to pay the second highest amount bid, and the second highest bidder is committed to pay the third highest bid amount. Assigning bidder obligations by transferred commitment is another (the seventh) characteristic exhibited by some embodiments of the present invention distinguishing them from the Dollar Auction.

Note that three of the factors distinguishing the Committed Bidder Auction from the Dollar Auction (numbers 4-6) have some relationship to how the bidding is closed. This issue is of more concern in a Committed Bidder Auction than in a Committed Winner Auction, particularly if the Committed Bidder Auction is conducted over a wide area network, such as the Internet. If a network auction closes at a fixed time known to the bidders, the minutes prior to the close of bidding are likely to be frantic. This will be especially true in an auction in which the runner-up bidder is committed to his full bid amount (i.e., a Committed Bidder Auction having a fixed known closing time but otherwise similar to the Dollar Auction). Such intense bidding in a short period is likely to engender frustration and misunderstanding, even litigation. The sealed bid format and the random closing time alternative embodiments can circumvent the frenetic last-minute rush.

In any network auction, a bid sent while the bidding is still open might not be received until after the bidding has closed. Network latency is especially problematic if the auction ends at a fixed time known to the bidders because of competition to win in the moments before close of bidding. To rectify this, one aspect of some embodiments of the invention is to consider all bids sent before the closing time and received within a grace period after the closing time, allowing all bids transmitted in the moments just before closing to be treated as timely. This approach is both fair to the bidders and can benefit the House by a higher sale price. As mentioned previously, the alternative of using a random closing time in a conventional auction is taught by Megiddo (U.S. Pat. No. 6,665,649 B1).

The present invention includes all Committed Bidder Auctions that are distinct from the Dollar Auction in any of the seven respects previously discussed, alone or in combination, and, in particular, it encompasses all Committed Bidder Auctions that involve transferred commitment. A number of specific embodiments are described in the Detailed Description of the Invention.

The preferred embodiment is an open bid format auction held over the Internet having a fixed closing time (with a grace period, as described above, for bids sent before closing but received after closing). The winner pays the full amount of his bid to the House, and receives the auctioned property. The unsuccessful bidders have a commitment amount equal to a percent f of what they have bid, where f is greater than zero and less than or equal to 100%. Values of f are less than 25,% are expected to be most successful, and values of 1% or less in the case of an Internet auction may be sufficient to raise significantly more revenue for the House than the value of the auctioned property. The resulting funds can be taken as profit. Alternatively, in a manner analogous to the use by Anderson et al. (U.S. Pat. No. 6,671,674) of their “redeemable fee” to participate, additional revenue can be used to lower the price for the winning bidder as an incentive for bidders to participate. Such a low percentage unsuccessful bidder commitment greatly mitigates the disincentive to participate found in the Dollar Auction.

### BRIEF DESCRIPTION OF THE DRAWINGS

FIG. 1 is a flowchart for an English Auction.

FIG. 2 is a flowchart for a Dollar Auction.

FIG. 3 is a flowchart for a Committed Bidder Auction.

FIG. 4a is a bar graph showing a percentage commitment function for an English Auction.

FIG. 4b is a bar graph showing a percentage commitment function for a Dollar Auction.

FIG. 4c is a bar graph showing a percentage commitment function used in a first embodiment of a Committed Bidder Auction.

FIG. 4d is a bar graph showing a percentage commitment function used in a second embodiment of a Committed Bidder Auction.

FIG. 4e is a bar graph showing a percentage commitment function used in third and fourth (a transferred commitment format) embodiments of a Committed Bidder Auction.

FIG. 5 is a table computing commitment amounts for a sample bidding sequence under relevant auction formats.

FIG. 6a is a bar graph showing the commitment amounts for all bidders in the sample bidding sequence under an English Auction format.

FIG. 6b is a bar graph showing the commitment amounts for all bidders in the sample bidding sequence under a Dollar Auction format.

FIG. 6c is a bar graph showing the commitment amounts for all bidders in the sample bidding sequence under a first embodiment of a Committed Bidder Auction format.

FIG. 6d is a bar graph showing the commitment amounts for all bidders in the sample bidding sequence under a second embodiment of a Committed Bidder Auction format.

FIG. 6e is a bar graph showing the commitment amounts for all bidders in the sample bidding sequence under a third embodiment of a Committed Bidder Auction format.

FIG. 6f is a bar graph showing the commitment amounts for all bidders in the sample bidding sequence under a fourth embodiment of a Committed Bidder Auction format.

### DETAILED DESCRIPTION OF THE INVENTION

Glossary of Terms

The following terms are relevant to the present invention.
auctioned property 3—the auctioned property is the property being sold in the auction. The property can be real estate or personal, and can be tangible or intangible. The property sold might be the right to receive a service, or an option contract.
auction rule 6—an auction rule is a rule that governs how the auction will be conducted. In a Committed Bidder Auction 27, auction rules can specify one or more of the following aspects of the auction: (1) the percentage commitment function 71; (2) whether the bidding will be open bid 63 or sealed bid 87; (3) the conditions governing close of bidding 18; (4) whether the auction is with reserve, and if so, what is the reserve criterion 81; and (5) whether the auction uses transferred commitments 90. The auction rules are published or otherwise made available to interested persons prior to the start of bidding.
auctioneer 9—an auctioneer is a person managing the bidding process, most often in an open bid format 66 auction in which the auctioneer 9 and the bidders 15 are all present in the same place.
bid 12—in an English Auction 42, a bid is an offer by a bidder 15 to buy the auctioned property 3 for a stated price. In a Committed Bidder Auction 27, a bid is a commitment by a bidder 15 to pay a commitment amount 21 determined by the auction rules 6, which will be nonzero for some unsuccessful bidders 93.
bidder 15—a bidder is a person who places a bid 12.
close of bidding 18—the close of bidding is the point in the auction at which bidding ends.
commitment amount 21—a commitment amount is an amount that (if nonzero) a given bidder 15 is committed to pay at the close of bidding 18 to the House 57 (or directly to the seller, who in this case would pay a cut to the House).
committed bidder 24—a committed bidder is either a winner 96 or a committed unsuccessful bidder 33.
Committed Bidder Auction 27—a Committed Bidder Auction is an auction format in which there is at least one committed unsuccessful bidder 33.
committed unsuccessful bidder 33—a committed unsuccessful bidder is an unsuccessful bidder 93 in a Committed Bidder Auction 27 who has a nonzero commitment amount 21.
Committed Winner Auction 36—a Committed Winner Auction is an auction format in which there is a winner 96 and no committed unsuccessful bidders 33.
Dollar Auction—a Dollar Auction is a Committed Bidder Auction 27 in which the highest bidder 15 is the winner 96. The runner-up 84 bidder 15 is a committed unsuccessful bidder 33. Each of the two highest bidders 15 has a commitment amount 21 equal to his final bid 45. Otherwise, the Dollar Auction format is identical to that of an English Auction 42.
English Auction 42—an English Auction is a type of Committed Winner Auction 36 conducted in an open bid format 66 by an auctioneer 9 in which the winner 96 receives the auctioned property 3 in exchange for the amount of his final bid 45.
final bid 45—a final bid is the last and largest bid made by a particular bidder 15.
final bid rank 48—the final bid rank is an ordering of final bids 45 from highest to lowest. The highest final bid 45 has final bid rank equal to 1, the second has final bid rank equal to 2, and so forth.
final bid set 51—a final bid set is a set containing pairs, one pair per bidder 15. Each pair associates the bidder 15 with his final bid 45 (which in turn is associated with a final bid rank 48).
first-price 54—a first-price auction is a Committed Winner Auction 36 in which the winner 96 pays the amount of his highest bid for the auctioned property 3.
House 57—the House consists of people or software controlling and conducting the auction process, and handling all administrative and financial aspects of the auction. An auctioneer 9 is a representative of the House. The primary function of the House is to sell property by auction on its own behalf or on behalf of other sellers.
open bid 63—an auction has an open bid format if the bidders 15 are aware of each other's bids during the bidding.
percentage commitment function 71—a percentage commitment function is a function that maps a final bid rank 48 to a percentage commitment 70.
person—a person is an entity entitled to bid in an auction. A person can be a human being, or it can be a business form such as a corporation, a partnership, or a limited liability company.
probability distribution 72—a probability distribution associates a probability with a given range of values that a random variable can have. Every probability distribution has a type (e.g., Gaussian (normal), Poisson, or exponential), and each type has a set of probability distribution parameter 75 specific to that type.
probability distribution parameter 75—probability distribution parameters specify a particular instance of a given type of probability distribution 72. For example, the mean and standard deviation of a Gaussian distribution specify the value at which its bell-shaped curve is centered, and how spread out that curve is, respectively. Which parameters are necessary to specify an instance of a probability distribution 72 are peculiar to the type of distribution.
reserve 78—an auction is said to be with reserve if one of its rules is a reserve criterion 81.
reserve criterion 81—a reserve criterion is a rule in an auction with reserve 78 that governs whether the House 57 can refuse to sell the auctioned property 3 at the close of bidding 18. For example, a Committed Bidder Auction 27 might have a reserve criterion that allows the House 57 to refuse to sell the auctioned property 3 unless the sum of all committed bids exceeds a certain amount.
runner-up 84—the runner-up is the bidder 15 who placed the final bid 45 having the second highest amount.
sealed bid auction 87—a sealed bid auction is an auction in which the House 57 keeps the bids secret from the bidders at large until the close of bidding 18.
transferred commitment auction 90—a transferred commitment auction is an auction in which at least one committed bidder 24 has a commitment amount 21 that is calculated from or based upon, in whole or in part, bids of other bidders 15.
unsuccessful bidder 93—an unsuccessful bidder is a bidder 15 who is not the winner 96. An unsuccessful bidder can be either committed or uncommitted.
winner 96—the winner is the winning bidder 99.
winning bid 98—the winning bid is the highest final bid 45 made during the auction.
winning bidder 99—the winning bidder is the bidder 15 that made winning bid 98. In all auction formats described herein, an auction has a unique winning bidder, who is the person who receives the auctioned property 3 at the close of bidding 18 from the House 57.
   English Auction

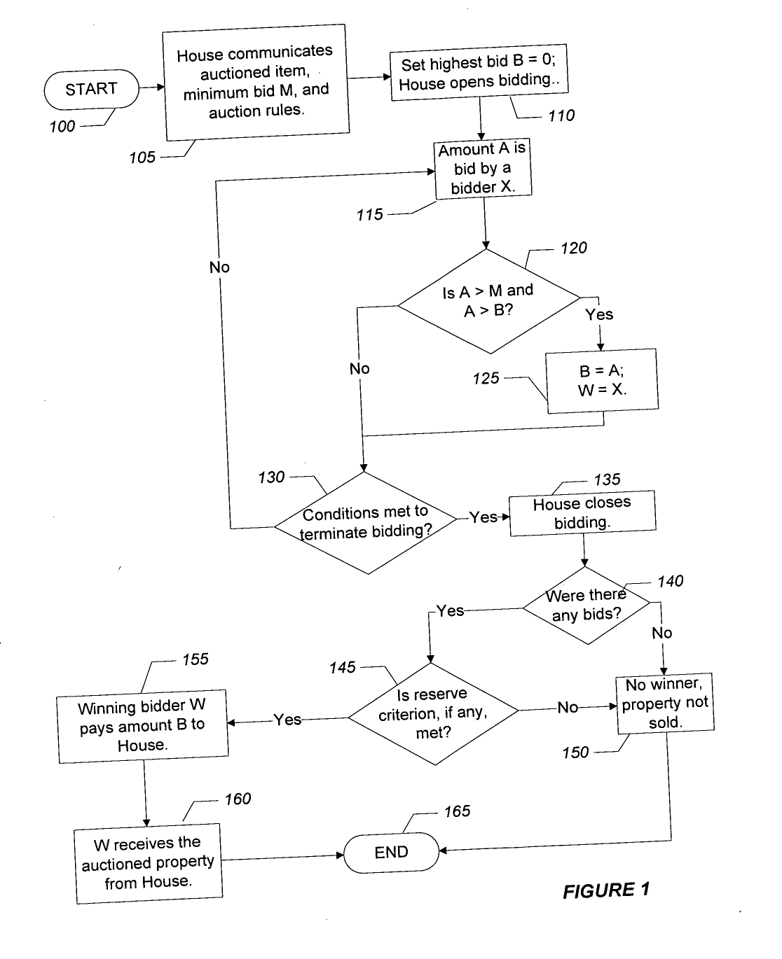

FIG. 1 is a flowchart depicting the method for conducting an English Auction 42. An English Auction 42 is illustrative of a Committed Winner Auction 36. It employs an open bid format 66 and is run by an auctioneer 9. Before the bidding starts the House 57 communicates 105 the auctioned property 3, the minimum bid 60, if any, and any auction rules 6. The communication of auction rules 6 will usually be explicit, but may be wholly or partly implicit instead, through course of dealing among the parties or custom of the industry. Usually the rules will be announced only once before the first of several consecutive auctions.

Some initialization is then done and the auction is opened 110. In the steps in FIG. 1 labeled 115 through 130, the bidding process determines which is the winning bid 98 (B) and who is the winner 96 (W). The House 57 then closes 135 bidding when specified by the termination criterion. If 140 there were no bids at all, or if 145 the reserve criterion 81, if any, was not met, no winner 96 is announced and the auctioned property 3 is not sold 150; otherwise, the winner 96 pays the amount B to the House 57 (or, as mentioned previously, directly to the seller), and in exchange receives 155 the auctioned property 3. The other bidders 15 are all uncommitted and receive nothing.

Dollar Auction

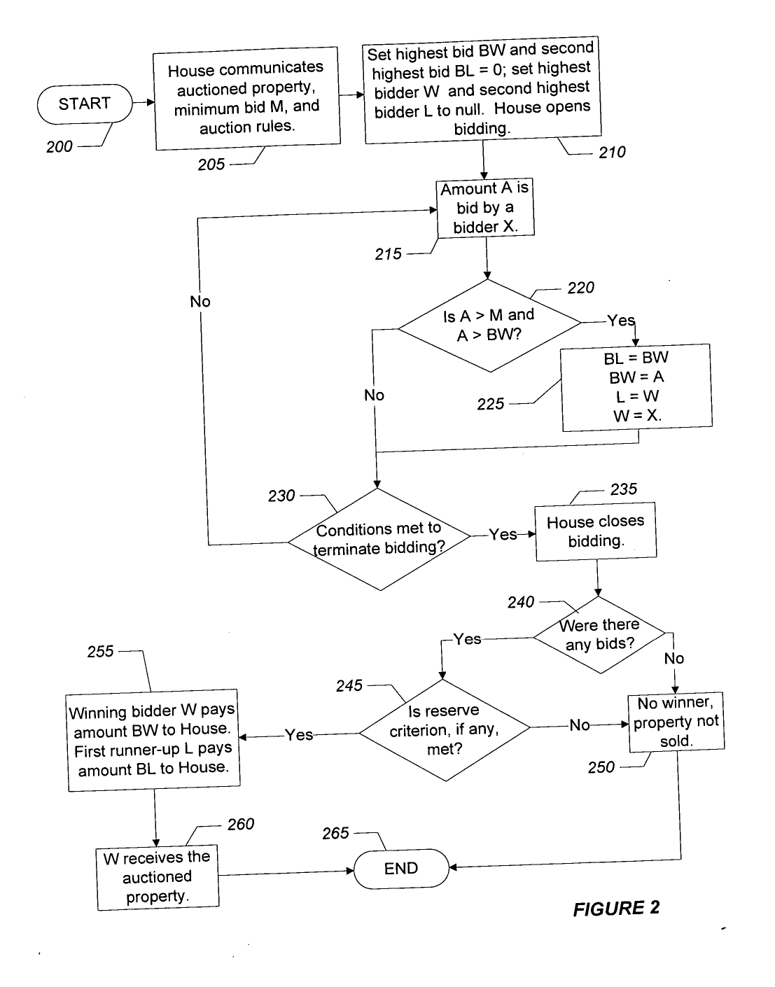

FIG. 2 is a flowchart for the Dollar Auction 39. The Dollar Auction 39 is the only prior art example of a Committed Bidder Auction 27, and in fact is a particularly simple construct that is unappealing to potential bidders 15. To facilitate comparison with the English Auction 42 (FIG. 1), corresponding steps in the two figures have callout numbers that differ only by the first digit (which is the figure number).

Most steps in the Dollar Auction 39 are the same as those of the English Auction 42. However, unlike the English Auction 42, the Dollar Auction 39 keeps track 225 of which two bids are the highest so far at any given time and the associated bidders 15. The winner 96 pays the amount of his bid 255 receives 260 the auctioned property 3. The runner-up 84 bidder 15 (L) is a committed unsuccessful bidder 33 whose commitment amount 21 is 255 the full amount of his final bid 45. L receives nothing in return.

Committed Bid Auction

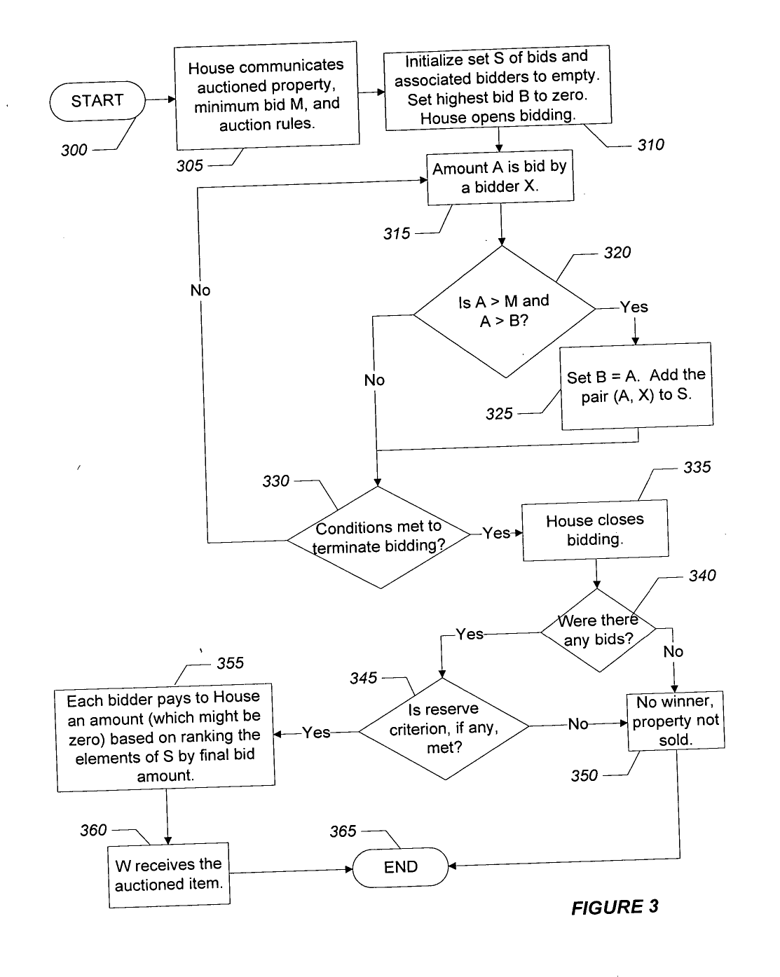

FIG. 3 is a flowchart illustrating the Committed Bidder Auction 27. This flowchart can be conveniently compared by corresponding callout numbers with those of the English Auction 42 (FIG. 1) and the Dollar Auction 39 (FIG. 2). In this case, a final bid set 51 S is initialized 310 and maintained such that, at any given point in the bidding, S contains 325 the highest bid and corresponding identity of each bidder 15.

After the House 57 closes 335 bidding when specified by the termination criterion and any reserve criterion 81 is applied 345, then the final bid rank 48 of the bids in S are used 355 to determine the commitment amounts 21 of the bidders 15. Except in some more complex embodiments of the transferred commitment format, the percentage commitment function 71 is applied to S. The percentage commitment function 71 assigns a percentage to each final bid rank 48. The percentage is multiplied by that bid which is associated with a given rank to obtain 355 the amount that the bidder 15 who made that particular bid must pay to the House 57 (or seller). The winner 96 receives 360 the auctioned property 3 from the House 57 and all unsuccessful bidders 93, whether committed or not, receive nothing.

If the auction does use transferred commitments 90 to determine liability to the House 57, then the commitment amount 21 of each bidder 15 is based, in whole or in part, on the values of the bids 12 of other bidders 15. The simplest embodiment involves a shift like that of a second-price 88 auction. That is, each bidder 15 pays the amount that, in a Committed Bidder Auction 27 not using transferred commitment 90, would have been paid by that bidder 15 who made the next lower final bid 45. In such an embodiment, the percentage commitment function 71 would be used to compute commitment amounts 21. A specific example of this basic type of transferred commitment 90 formulation will be illustrated in the description below.

In some more complex transferred commitment 90 embodiments, the percentage commitment function 71 might not be involved in the commitment calculation. An example would be if the commitment amount 21 assigned to a given bidder 15 were the average of his final bid 45 and all lower final bids 45. Again, all possible transferred commitment 90 formulations within a Committed Bidder Auction 27 auction are embodiments of the present invention.

Percentage Commitment Function

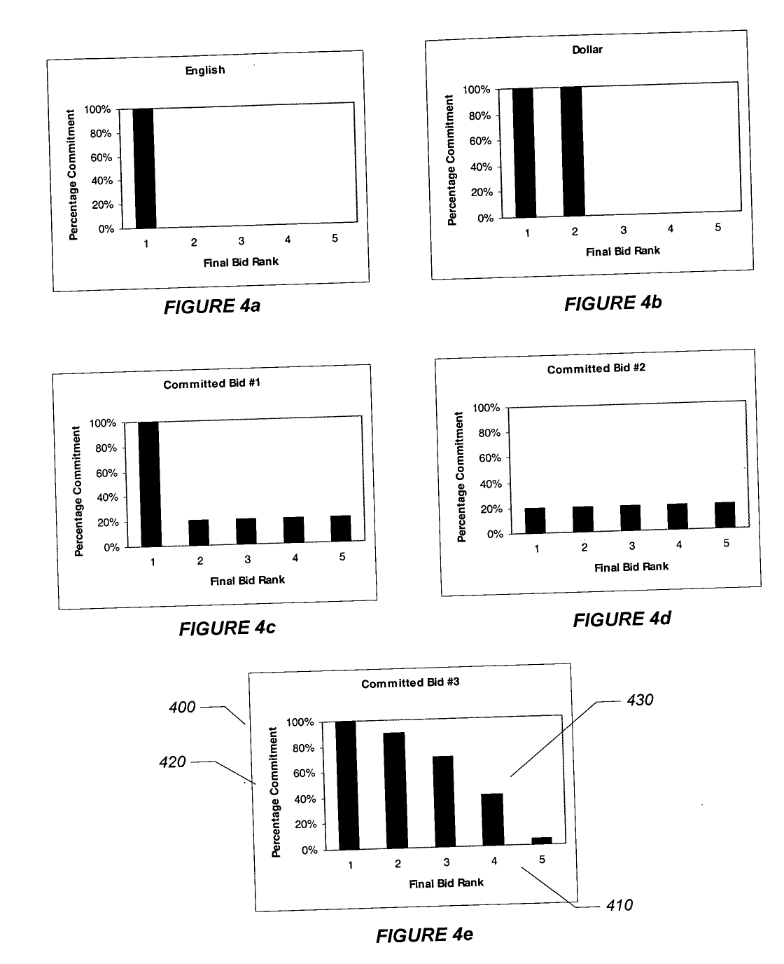

Specific percentage commitment functions 71 are illustrated for the English Auction 42 (FIG. 4a), the Dollar Auction 39 (FIG. 4b), and for three embodiments of the Committed Bidder Auction 27, designated #1 (FIG. 4c), #2 (FIG. 4d), and #3 (FIG. 4e). FIG. 4e typifies the form and content of these five drawings 400. The horizontal axis 410 is final bid rank 48. The final bid rank 48 of a bidder 15 is determined by comparing the final (and largest) bid by that bidder 15 against the final bids 45 of the other bidders 15. The highest final bid 45 has final bid rank 48 equal to 1; the second highest has final bid rank 48 equal to 2; and so forth. The vertical axis 420 is percentage commitment. Each drawing shows, for the particular auction type, the percentages 430 of the top 5 final bids 45 that must be paid by their respective bidders 15.

As shown in FIG. 4a, the winning bidder 99 in the English Auction 42 pays 100% of his final bid 45. The other bidders 15 pay nothing. In sharp contrast, FIG. 4b shows that in the Dollar Auction 39 the bidder 15 associated with the second highest bid must also pay 100% of that bid's amount. The Dollar Auction 39 has only one committed unsuccessful bidder 33, and the Dollar Auction 39 is always conducted with an open bid format 66. Consequently, at any point during the bidding, the person currently holding the second place bid is aware of the higher bid and that he must bid a bit higher still or he will necessarily lose the amount of his last bid. Once he has bid again, a competitor now occupies the precarious number two position, and is subject to the same intense pressure to reacquire first place.

The Dollar Auction 39 is exceedingly harsh, and for that reason would be unpopular and not viable for commercial contexts. The purpose of the present invention is to generalize the Dollar Auction 39. Some of embodiments are significantly more equitable than the Dollar Auction 39 and are commercially attractive.

If the English Auction 42 and the Dollar Auction 39 can be regarded, in some sense, as extremes in terms of their percentage commitment functions 71, then the preferred embodiment of the invention, a variation of which is shown in FIG. 4c, takes an intermediate position. In the preferred embodiment, as in both the English Auction 42 and the Dollar Auction 39, the winner 96 still pays 100%. All the other bidders 15 pay a uniform percentage f where f is greater than zero, and less than or equal to 1. Note that if f were allowed to be equal to zero, then this embodiment of the Committed Bidder Auction 27 would degenerate to the English Auction 42. Consequently, we require f to be strictly positive.

If f were equal to 100%, every bidder 15 would be required to pay his full bid. Instead of one bidder 15 being strongly goaded into increasing the highest bid as in the Dollar Auction 39, all participants would have the choice between bidding higher or losing whatever they have bid. On the other hand, at least in this embodiment of the invention nearly everyone has to pay something, so that no one person has to be concerned about feeling like the only loser in the crowd. Because of the penalty for bidding, not present in the English Auction 42, people might tend to just make low bids with the idea that they might get something for a bargain.

The specific variant of the preferred embodiment depicted in FIG. 4c is suggestive of the range of values of f that are likely to be commercially successful. In this case, the winner 96 pays his full final bid 45, and each unsuccessful bidder 93 pays the same small fraction f of what she has bid. Any value of f less than about 25% can be expected to work well. The larger the potential bidder 15 pool, the smaller f can be to still turn a significant profit for House 57 (and for the seller, if distinct) by sale of the auctioned property 3 for (possibly substantially) more than it is worth. When the sale is conducted over a wide area network such as the Internet, f can be profitably set at a nonzero value significantly lower than 1% if the auctioned property 3 is interesting to consumers.

Another embodiment of the invention is shown in FIG. 4d. As mentioned previously, in this case, each bidder 15 pays the same amount, only a fraction g of what they have bid. The same value of g applies to both the winner 96 and the committed unsuccessful bidders 33. Here it appears that the winner gets a windfall!

While this form of percentage commitment function 71 might at first seem to be significantly different from the one of the preferred embodiment, in actuality it turns out to be equivalent to the variant described previously in which all bidders 15 pay the full amounts of their bids. They are equivalent because there is no restriction on how high someone can bid. Consequently, if g is 10% and the item being sold is worth $100, then a bidder 15 who is successful with a bid of $1,000 would not have lost any money.

(The essence of the discussion in the previous paragraph can be abstracted into a principle applicable to percentage commitment functions 71 generally. It is only how the heights for various final bid ranks 48 in a percentage commitment function 71 relate to each other that matters. The absolute height, or scaling of the vertical axis, is immaterial. Note that this is true even for the English Auction 42, although needless to say some bidders 15 would be initially confused if they were told they only need to pay, say, 5% of what they bid for an item as the winning bidder 99.)

The graph shown in FIG. 4e is exemplary of the fully general embodiment of a percentage commitment function 71. The particular shape illustrated has the percentage commitment decreasing as final bid rank 48 increases, but that need not be so. In this class of embodiments, the percentage commitment function 71 can have an arbitrary shape. For example, in principle, some ordinates could even be negative. A negative ordinate for a given final bid rank 48 would imply that the House 57 must pay some amount to the corresponding bidder 15 (and so, from the standpoint of the House 57, presumably at least some of the ordinates better be positive). The percentage commitment functions 71 for the English Auction 42, the Dollar Auction 39, as well as the percentage commitment functions 71 for the Committed Bidder Auctions 27 shown in FIG. 4x, are all special instances of the general percentage commitment function 71 embodiment.

Example Bid Sequences

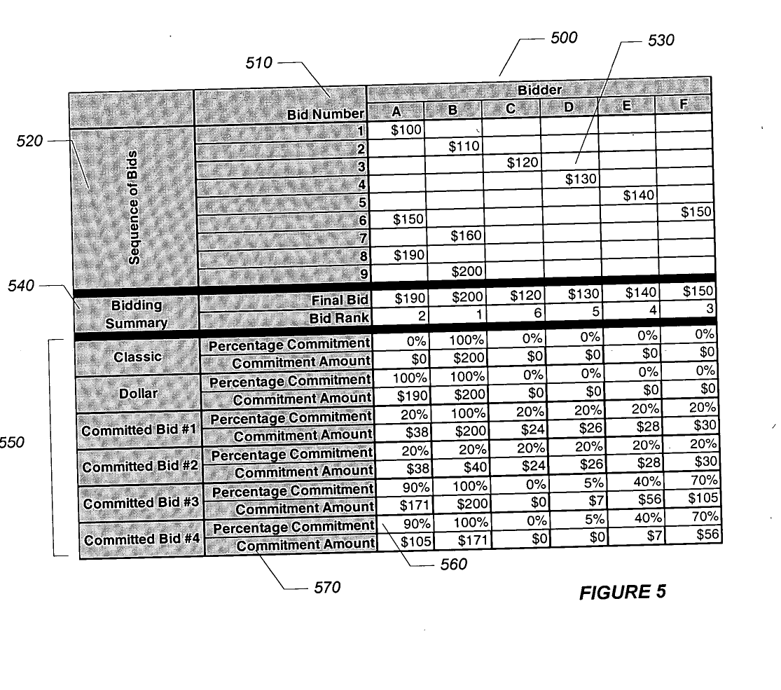

FIG. 5 is a table showing a sequence of bids in an example auction. There are six bidders 15, labeled 500 A through F. A bid number 510 increases sequentially in time as the bidding progresses 520. Corresponding to each bid number is a bid 530 made by one of the bidders 15. This is an open auction example, so each successive bid is larger than the preceding one. A total of 9 bids have been made by the close of bidding 18.

In the table, below the bid sequence, is a bidding summary 540. The bidding summary shows the final bid 45 made by each bidder 15 and the associated final bid rank 48.

Below the bidding summary, each of the five percentage commitment functions 71 illustrated in FIG. 4 is applied 550 to the bid rank set contained in the bid summary. In addition, a variant (#4) that uses the same percentage commitment function 71 as #3 has been added as an example of a Committed Bidder Auction 27 that uses transferred commitment 90. For each percentage commitment function 71, the percentage commitments 560 and the commitment (monetary) amount 570 for each bidder 15 are shown.

In the transferred commitment 90 example (#4), each bidder was assigned the commitment amount 21 that the percentage commitment function 71 associated with the next lower bidder in the Committed Bidder Auction 27 of example #3. Note the similarity of this kind of shifted commitment amount 21 to the conventional Committed Winner Auction 36 using a second-price format 88. Transferring commitment by shifting is an elementary embodiment of a transferred commitment format 90 embodiment of a Committed Bidder Auction 27. The more general case, covered by the present invention, includes all cases in which the commitment amount 21 of a bidder is calculated in whole or in part from the bids of other bidders (and possibly in part from his own bid).

Commitment Amounts

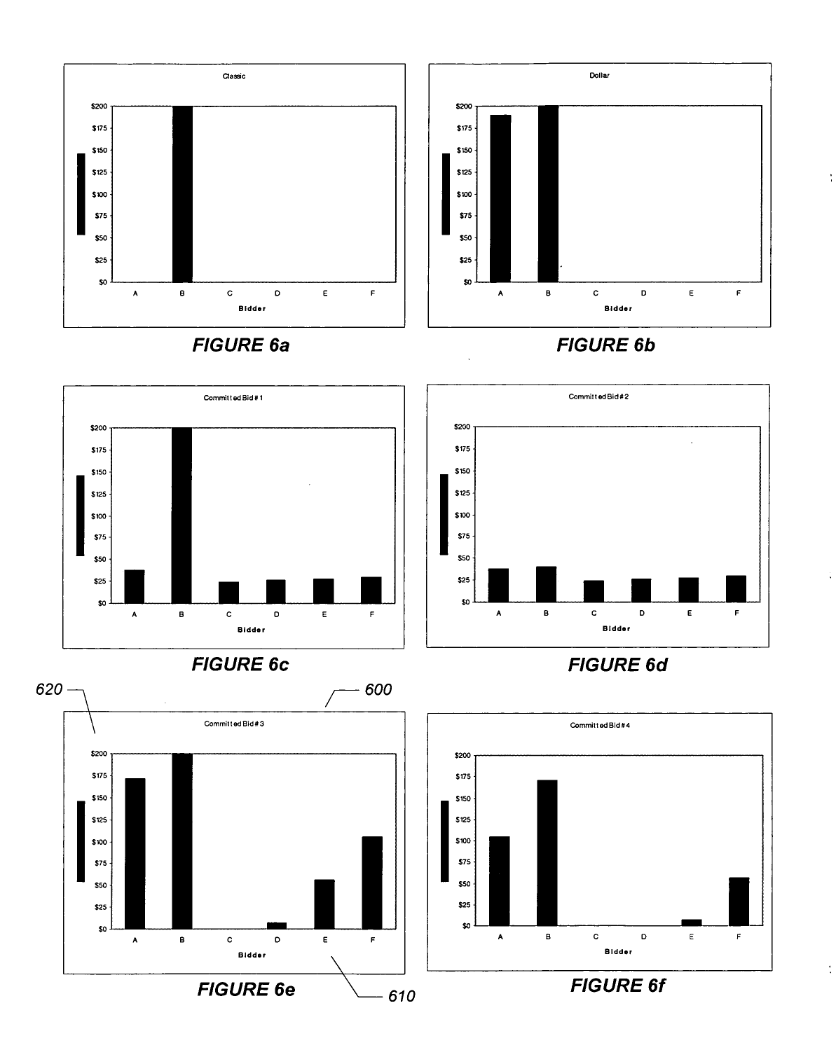

The commitment amounts 21 calculated in FIG. 5 corresponding to the six percentage commitment functions 71 of that figure are illustrated for the English Auction 42 (FIG. 6a), the Dollar Auction 39 (FIG. 6b), and Committed Bidder Auctions 27 for four embodiments of the present invention, designated #1 (FIG. 6c), #2 (FIG. 6d), #3 (FIG. 6e), and #4 (FIG. 6f). The graph 600 of FIG. 6e typifies all FIG. 6x graphs. The horizontal axis 610 represents bidders from FIG. 5 and the vertical axis 620 depicts the corresponding commitment amount 21 for that bidder. The values of commitment amount 21 are taken from the line in the table of FIG. 5 labeled “Commitment Amount” corresponding to “Committed Bid #3.”

Each of the six auction formats gives dramatically different results in terms of what bidders 15 are obliged to pay to participate. Obviously, bidding motivation and strategy will vary greatly under each of these types of auction.

Closing the Bidding

The method for close of bidding 18 is an important aspect of the present invention. As described previously, a Committed Bidder Auction 27 closing at a time certain is likely to have considerable activity in the closing moments as bidders 15 compete to have the last and winning bid. If the auction is held over the Internet, network latency is likely to play a significant role in the final moments. Almost inevitably, someone will submit a bid that is higher than any previous bids (and hence should be the winner 96), but that is not received until after the bidding closes. This situation invites controversy, even litigation.

While conventional methods of closing an auction are encompassed by the invention (i.e., closing at a specific time, or closing when an auctioneer 9 surmises that no further bids 12 are likely forthcoming), alternative methods are also possible. One approach is a sealed bid 87 auction, in which the participants are not even aware of each other's bids.

Another approach within the present invention entails specifying in advance of bidding two times t0 and t1, where t0 is the official closing time of the auction. A bid that was sent before t0 and received before t1 will be accepted; the grace period from t0 to t1 would be sufficiently long to account for essentially all problems with network latency.

A third alternative (using Megiddo, U.S. Pat. No. 6,665,649 B1) is to end the auction at a random time, where the randomization would occur in advance of the auction but the particular closing time so determined would be kept secret from the participants. This approach is described by Megiddo (U.S. Pat. No. 6,665,649). Megiddo teaches the use of an exponential distribution in performing the randomization, but a variety of probability distributions are possible. The participants would be fully informed in advance of the distribution and associated parameters used in the scheme to select the closing time.

The present invention is not to be limited to all of the above details, as modifications and variations may be made without departing from the intent or scope of the invention. Consequently, the invention should not be limited by the specifics of the above description, but rather be limited only by the following claims and equivalent constructions.

What is claimed is:

1. A Committed Bidder Auction, comprising:
a) a House that manages the sale of an item of auctioned property;
b) a plurality of bidders;
c) a start of bidding and a close of bidding set by the House;
d) for each bidder, a distinct final bid including a final bid amount, said final bid being the highest bid for the auctioned property made by said bidder after the start of bidding and prior to the close of bidding;
e) a ranking of the final bids from all bidders in decreasing order by final bid amount;
f) a commitment amount of each bidder, which said bidder is obligated to pay to the House, calculated from the rank and final bid amount associated with said bidder;
g) a winning bidder, whose final bid had the largest final bid amount, that receives the auctioned property from the House; and
h) two unsuccessful bidders having commitment amounts that are positive.

2. The Committed Bidder Auction of claim 1, further comprising:
i) a percentage commitment function associating a percentage commitment with each final bid rank, whereby the commitment amount of a bidder is calculated by multiplying the final bid rank associated with that bidder by the percentage commitment associated with said final bid rank.

3. The Committed Bidder Auction of claim 2, wherein the percentage commitment function associates 100% with the final bid rank that corresponds to the highest final bid amount, and associates a uniform percentage f with all other final bid ranks, said percentage f greater than 0 and less than or equal to 100%.

4. The Committed Bidder Auction of claim 1, wherein the auction is a sealed bid auction.

5. The Committed Bidder Auction of claim 1, further comprising:
i) a fixed closing time t0, selected by the House prior to the start of bidding, at which time the close of bidding will occur.

6. The Committed Bidder Auction of claim 5, wherein the value of t0 is calculated at random, according to a probability distribution having a type, and specific values of parameters associated with the type, said value of t0 kept secret by the House until the close of bidding has occurred.

7. The Committed Bidder Auction of claim 5, wherein the auction is conducted over an electronic network, and wherein bids transmitted by a bidder at or before t0 and received by the House at or before a later time t1 selected by the House prior to the start of bidding, will be treated as timely bids.

8. The Committed Bidder Auction of claim 1, wherein said auction is conducted over an electronic network.

9. The Committed Bidder Auction of claim 1, further comprising:
i) a reserve amount such that if the sum of the commitment amounts of all bidders is less than the reserve amount, then the House is not obligated to sell the auctioned property.

10. A Committed Bidder Auction with transferred commitments, comprising:
a) a House that manages the sale of an item of auctioned property;
b) a plurality of bidders;
c) a start of bidding and a close of bidding set by the House;
d) for each bidder, a distinct final bid including a final bid amount, said final bid being the highest bid for the auctioned property made by said bidder prior to the close of bidding;
e) a ranking of the final bids from all bidders in decreasing order by final bid amount;
f) a transferred commitment amount of a bidder, which said bidder is obligated to pay to the House, calculated from the rank and final bid amount of one or more other bidders;
g) a winning bidder, whose final bid had the largest bid amount, that receives the auctioned property from the House; and
h) an unsuccessful bidder having a commitment amount that is positive.

11. A process for a Committed Bidder Auction, comprising:
a) creating a commitment percentage function mapping a bid rank r to a commitment percentage p(r), where r is in the set of all integers greater than zero, and three values of r are mapped to positive values of p(r);
b) conducting an auction accepting bids to purchase auctioned property;
c) closing the bidding;
d) assigning to the final bid of each bidder a rank, with the highest final bid being assigned a rank of 1, and each successively lower final bid being assigned a rank one higher than that of its predecessor; and
e) requiring each bidder to pay to the House a commitment amount, said commitment amount equal to the amount of the final bid of said bidder, multiplied by the commitment percentage associated by the commitment percentage function p(r) with the rank r of said final bid.

12. The process of claim 11, wherein the commitment percentage function associates 100% with rank r=1 and a positive uniform value f with all values of rank r greater than 1.

13. The process of claim 11, further comprising:
f) prior to the start of bidding, selecting a fixed closing time t0 at which time the close of bidding will occur.

14. The process of claim 13, wherein t0 is calculated at random, according to a probability distribution and specific values of parameters associated with its type, and is kept secret by the House until the close of bidding has occurred.

15. The process of claim 13, further comprising:
f) conducting the auction over an electronic network; and
g) accepting as timely bids transmitted at or before t0 and received at or before a later time t1, selected by the House prior to the start of bidding.

16. The process of claim 11, further comprising:
f) conducting the auction over an electronic network.

17. The process of claim 11, further comprising:
f) setting a reserve amount such that if the sum of the commitment amounts of all bidders is less than the reserve amount, then the House is not obligated to sell the auctioned property.
